(19) United States
(12) Patent Application Publication
(10) Pub. No.: US 2007/0060661 A1
(43) Pub. Date: Mar. 15, 2007

(54) High mobility low emission surfactants for polyurethane foams

(76) Inventor: Roger C. Clark, Vienna, WV (US)

Correspondence Address: DILWORTH & BARRESE, LLP, 333 EARLE OVINGTON BLVD., UNIONDALE, NY, 11553, US

(21) Appl. No.: 11/227,920

(22) Filed: Sep. 15, 2005

(51) Int. Cl. C08J 9/00

(52) U.S. Cl. 521/134

(57) ABSTRACT

The invention relates to the use of high mobility, low emission silicone copolymer surfactants for the production of polyurethane foams.

### BACKGROUND OF THE INVENTION

This application provides for the use of certain silicone copolymers as surface-active substances in the production of polyurethane foams.

In polyurethane foam manufacturing surfactants are needed to stabilize the foam until the product-forming chemical reaction is sufficiently complete so that the foam supports itself and does not suffer objectionable collapse. High potency surfactants, generally understood to be those which give a high height of rise and little top collapse, are desirable because foams which collapse to a substantial degree before setting have high densities and objectionable density gradients.

Polyether polyols based on the polymerization of alkylene oxides, and/or polyester polyols, are the major components of a polyurethane system together with isocyanates. These systems generally contain additional components such as cross-linkers, chain extenders, surfactants, cell regulators, stabilizers, antioxidants, flame retardant additives, eventually fillers, and typically catalysts such as tertiary amines and/or organometallic salts.

Organometallic catalysts, such as lead or mercury salts, can raise environmental issues due to leaching upon aging of the polyurethane products. Others, such as tin salts, are often detrimental to polyurethane aging.

The commonly used tertiary amine catalysts give rise to several problems, particularly in flexible, semi-rigid and rigid foam applications. Freshly prepared foams using these catalysts often exhibit the typical odor of the amines and give rise to increased fogging, i.e. emission of volatile siloxane copolymer products.

The presence, or formation, of even traces of volatile organic compounds (e.g. amines) can be disadvantageous for environmental and health reasons. Such products commonly appear in automotive interiors as seats, armrests, dashboards or instrument panels, sun visors, door linings, noise insulation parts either under the carpet or in other parts of the car interior or in the engine compartment, as well as in many domestic applications such as shoe soles, cloth interliners, appliance, furniture and bedding. While these materials perform excellently in these applications, they possess a deficiency that has been widely recognized. Polycarbonate decomposition problems are especially prevalent in environments wherein elevated temperatures exist for long periods of time, such as in automobile interiors, which favor emission of amine vapors.

In response to these problems, catalyst suppliers generally propose amine catalysts that contain a hydrogen isocyanate reactive group such as a hydroxyl or a primary, and/or a secondary amine. A reported advantage of these catalyst compositions is that they are incorporated into the polyurethane product. However, those catalysts are usually used at high levels in the polyurethane formulation to compensate for their lack of mobility during the polyurethane foam-forming reaction to obtain normal processing conditions. As a result generally not all of these molecules have time to react with isocyanates and some traces of free amine are typically present in the final product, especially in the case of fast gelling and fast curing systems.

Modification of polyols by partial amination gives additional reactivity to the polyol; however, this does not allow adjustment of processing conditions since these aminated functions are rapidly tied in the polymer by reacting with the isocyanate. Hence, they give fast initiation of the reactions but subsequently loose most of their catalytic activity and do not provide proper final curing.

The industry is driving more and more to reduced emissions for additives, thus it would be beneficial to have a cell opening additive with low emissions. In flexible molded foam, reduced emissions of additives can lead to reduced fogging on interior automobile windshields. In rigid foam, reduced emissions could be beneficial for establishing stable, low-pressure vacuums in rigid foam filled vacuum panels.

Currently, manufacturers of polyurethane foams use hydroxy functionalized pendant groups for silicone copolymers that react into the polyurethane system to reduce emissions from the finished polyurethane products. However, hydroxy functionalization has negative effects on open cell content and mobility of the silicone copolymer in the formation of the foam matrix. Use of hydroxy functionalized materials and epoxy containing materials for foam control are disclosed in WO 00056805A1, and U.S. Pat. Nos. 6,746,623 and 6,656,977, respectively, each of which are incorporated herein by reference.

Therefore, it is an object of the present invention to produce polyurethane products with reduced emissions through the use of epoxy containing materials such as allyl glycidyl ether (AGE), as pendant groups for silicone copolymers in polyurethane foam-forming compositions, for applications where low emissions are desirable.

### BRIEF SUMMARY OF THE INVENTION

The present invention pertains to a polyurethane foam-forming composition for making polyurethane foam products with reduced volatile organic compound emissions. The polyurethane foam-forming composition comprising:

(a) polyether, polyester or polymer polyol;

(b) organic diisocyanate or polymer isocyanate;

(c) catalyst for production of polyurethane foam; and

(d) silicone copolymer having alkyl, aryl, polyether, polyester, pendant groups with at least one oxyrane or epoxy functionality.

Various other features, aspects, and advantages will become more apparent with reference to the following description, examples, and appended claims.

### DETAILED DESCRIPTION OF THE INVENTION

In accordance with the present invention, a process for the production of polyurethane products is provided, whereby polyurethane products of relatively low odor and emission are produced. Furthermore, the polyurethane products produced in accordance with the invention exhibit and are more environmental friendly.

These advantages are achieved by including in the reaction mixture epoxy containing materials such as allyl glycidyl ether (AGE) as pendant groups of the silicone copolymers. These materials may be represented by the formulas: 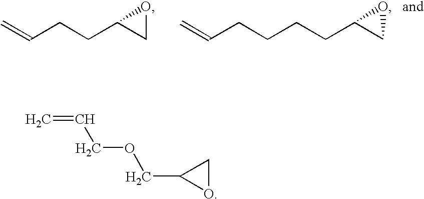
This novel approach allows these products to maintain their mobility in the initial stages of the polyurethane foam-forming composition reaction by not reacting with the isocyanate until the ring opening is catalyzed by temperature increases, and thereby improve processing of the foam. While they are eventually catalyzed with typical catalytic amines, such as tertiary amine used in the manufacture of polyurethane foam, at temperatures that typically occur in the polyurethane foam process, the epoxy groups open and form hydroxyl terminated end groups that react in the foam mixture. The ring-opened material then reacts into the foam via conventional urethane chemistry. The delayed reactivity, via the unopened ring structures of the pendant groups, allows the silicone surfactant to be mobile during the critical initial stages of the polyurethane foam formation. As a result, the emissions are reduced because the ring-opened material reacts in the foam matrix and allows the silicone terpolymer (copolymer) to be bound chemically into the final foam product.

This process is applicable in polyurethane foam using any polyfunctional aromatic or aliphatic isocyanate such as methylene diphenyl diisocyanate (MDI) and 2,4- and 2,6-toluene diisocyanate (TDI), or blends thereof and 2 to 12 functional polyols or polyamines that can be reacted with isocyanates to form polyurethane foams. Polyol (a) is at least one of the type generally used to prepare polyurethane foams, specifically, polyether polyol (a) can have a molecular weight of from about 200 to about 7000. The phrase “polyol” includes linear and branched polyethers (having ether linkages), polyesters and blends thereof, and comprising at least two hydroxyl groups. It will be understood by a person skilled in the art that these ranges include all subranges there between.

Non-limiting examples of suitable polyols (a) are those derived from propylene oxide and ethylene oxide and an organic initiator or mixture of initiators of alkylene oxide polymerization and combinations thereof. The average number of hydroxyl groups in polyether polyol (a) is achieved by control of the functionality of the initiator or mixture of initiators used in producing polyether polyol (a).

In one specific embodiment, polyol (a) can have a functionality of from about 2 to about 12, in a more specific embodiment of the present invention the polyol has a functionality of at least 2. It will be understood by a person skilled in the art that these ranges include all subranges there between.

Some non-limiting examples of polyether, polyester or polymer polyols that can be used include polyoxypropylene polyether polyol or mixed poly (oxyethylene/oxypropylene) polyether polyol. In one embodiment, some specific examples of polyether polyol (a) are polyoxyalkylene polyol, particularly linear and branched poly (oxyethylene) glycol, poly (oxypropylene) glycol, copolymers of the same and combinations thereof. Graft or modified polyether polyols are those polyether polyols having at least one polymer of ethylenically unsaturated monomers dispersed therein. Non-limiting representative modified polyether polyols include polyoxypropylene polyether polyol into which is dispersed poly (styrene acrylonitrile) or polyurea, and poly (oxyethylene/oxypropylene) polyether polyols into which is dispersed poly (styrene acrylonitrile) or polyurea. Graft or modified polyether polyols comprise dispersed polymeric solids. Suitable polyesters of the present invention, include but are not limited to aromatic polyester polyols such as those made with pthallic anhydride (PA), dimethlyterapthalate (DMT) polyethyleneterapthalate (PET) and aliphatic polyesters, and the like. As such, the solids increase hardness and mechanical strength of polyurethane foam. In one another embodiment of the present invention, the polyether polyol (a) is selected from the group consisting of ARCOL® polyol U-1000, Hyperlite E-848 from Bayer AG, Voranol Dow BASF, Stepanpol from Stepan, Terate from Invista and combinations thereof.

Organic diisocyanate (b) of the present invention, can be any diisocyanate that is commercially or conventionally used for production of polyurethane foam. In one embodiment of the invention, the organic diisocyanate (b) can be organic compound that comprises at least two isocyanate groups and generally will be any of the known aromatic or aliphatic diisocyanates.

In another embodiment of the invention, the organic diisocyanate (b) can be a hydrocarbon diisocyanate, (e.g. alkylenediisocyanate and arylene diisocyanate), such as toluene diisocyanate, diphenylmethane isocyanate, including polymeric versions, and combinations thereof. In yet another embodiment of the invention, the organic diisocyanate (b) can be isomers of the above, such as methylene diphenyl diisocyanate (MDI) and 2,4- and 2,6-toluene diisocyanate (TDI), as well as known triisocyanates and polymethylene poly(phenylene isocyanates) also known as polymeric or crude MDI and combinations thereof. Non-limiting examples of isomers of 2,4- and 2,6-toluene diisocyanate include Mondur® TDI, _Papi 27 MDI and combinations thereof. For more rigid polyurethane foams, isocyanates are used, e.g., diisocyanates of MDI type and specifically crude polymeric MDI.

In one specific embodiment organic diisocyanate (b) can be at least one mixture of 2,4-toluene diisocyanate and 2,6-toluene diisocyanate wherein 2,4-toluene diisocyanate is present in an amount of from about 80 to about 85 weight percent and wherein 2,6-toluene diisocyanate is present in an amount of from about 20 to about 15_weight percent. It will be understood by a person skilled in the art that these ranges include all subranges there between.

The amount of organic diisocyanate (b) included in polyurethane foam-forming composition relative to the amount of other materials in polyurethane foam-forming composition is described in terms of “Isocyanate Index”. “Isocyanate Index” means the actual amount of organic diisocyanate (b) used divided by the theoretically required stoichiometric amount of organic diisocyanate (b) required to react with all active hydrogen in polyurethane foam-forming composition multiplied by one hundred (100). In one specific non-limiting embodiment the Isocyanate Index in the polyurethane foam-forming composition used in the process herein is of from about 60 to about 300, more specifically, of from about 70 to about 200 and most specifically of from about 80 to about 120. It will be understood by a person skilled in the art that these ranges include all subranges there between.

Catalyst for production of polyurethane foam (c) can be a single catalyst or at least one mixture of polyurethane catalysts normally used to catalyze reaction of polyol with diisocyanate. It is common to use both an organoamine and an organotin compound for this purpose. Suitable non-limiting examples of polyurethane foam-forming catalysts are well known in the art and include (i) tertiary amines such as bis(2,2′-dimethylamino)ethyl ether, trimethylamine, triethylamine, N-methylmorpholine, N,N-ethylmorpholine, N,N-dimethylbenzylamine, N,N-dimethylethanolamine, N,N,N′,N′-tetramethyl-1,3-butanediamine, pentamethyldipropylenetriamine, triethanolamine, triethylenediamine, pyridine oxide and the like; (ii) strong bases such as alkali and alkaline earth metal hydroxides, alkoxides, and phenoxides; (iii) acidic metal salts of strong acids such as ferric chloride, stannous chloride, antimony trichloride, bismuth nitrate and chloride, and the like; (iv) chelates of various metals such as those which can be obtained from acetylacetone, benzoylacetone, trifluoroacetylacetone, ethyl acetoacetate, salicylaldehyde, cyclopentanone-2-carboxylate, acetylacetoneimine, bis-acetylaceone-alkylenediimines, salicylaldehydeimine, and the like, with the various metals such as Be, Mg, Zn, Cd, Pb, Ti, Zr, Sn, As, Bi, Cr, Mo, Mn, Fe, Co, Ni, or such ions as MoO₂++, UO₂++, and the like; (v) alcoholates and phenolates of various metals such as Ti(OR)₄, Sn(OR)₄, Sn(OR)₂, Al(OR)₃, and the like, wherein R is alkyl or aryl of from 1 to about 18 carbon atoms, and reaction products of alcoholates with carboxylic acids, beta-diketones, and 2-(N,N-dialkylamino) alkanols, such as well known chelates of titanium obtained by this or equivalent procedures; (vi) salts of organic acids with a variety of metals such as alkali metals, alkaline earth metals, Al, Sn, Pb, Mn, Co, Bi, and Cu, including, for example, sodium acetate, potassium laurate, calcium hexanoate, stannous acetate, stannous octoate, stannous oleate, lead octoate, metallic driers such as manganese and cobalt naphthenate, and the like; (vii) organometallic derivatives of tetravalent tin, trivalent and pentavalent As, Sb, and Bi, and metal carbonyls of iron and cobalt; and combinations thereof. In one specific embodiment organotin compounds that are dialkyltin salts of carboxylic acids, can include the non-limiting examples of dibutyltin diacetate, dibutyltin dilaureate, dibutyltin maleate, dilauryltin diacetate, dioctyltin diacetate, dibutyltin-bis(4-methylaminobenzoate), dibuytyltindilaurylmercaptide, dibutyltin-bis(6-methylaminocaproate), and the like, and combinations thereof. Similarly, in another specific embodiment there may be used trialkyltin hydroxide, dialkyltin oxide, dialkyltin dialkoxide, or dialkyltin dichloride and combinations thereof. Non-limiting examples of these compounds include trimethyltin hydroxide, tributyltin hydroxide, trioctyltin hydroxide, dibutyltin oxide, dioctyltin oxide, dilauryltin oxide, dibutyltin-bis(isopropoxide) dibutyltin-bis(2-dimethylaminopentylate), dibutyltin dichloride, dioctyltin dichloride, and the like, and combinations thereof.

In one embodiment of the invention, the catalyst for production of polyurethane foam (c) can be organotin catalysts selected from the group consisting of stannous octoate, dibutyltin dilaurate, dibutyltin diacetate, stannous oleate and combinations thereof. In a another embodiment, catalyst for production of polyurethane foam (c) can be stannous octoate, dibutyltin dilaurate and combinations thereof. In another specific embodiment, catalyst for production of polyurethane foam (c) can be organoamine catalyst, for example, tertiary amine such as trimethylamine, triethylamine, triethylenediamine, bis(2,2′-dimethylamino)ethyl ether, N-ethylmorpholine, diethylenetriamine and combinations thereof. In yet another embodiment of the invention, the catalyst for production of polyurethane foam (c) can be selected from the group consisting of tertiary amine and glycol, stannous octoate, di-metallic cyanide catalyst and combinations thereof. In still another embodiment of the invention, the catalyst for production of polyurethane foam (c) can include tertiary amine and glycol, such as Niax® A-1, Niax® A-33, Niax® catalyst C-183, stannous octoate, such as Niax® catalyst D-19 and combinations thereof, all available from General Electric Company.

In an additional embodiment the catalyst can be an amine, metal salt, triazine and or a quaternary ammonium salt that produces isocyanurate moieties along with urethane linkages. Trimerization catalysts usable for the present invention can be selected from conventional polyisocyanate-trimerization catalysts. For example, the trimerization catalyst may be alkali salts of aliphatic, cycloaliphatic and aromatic carboxylic acids, for example, potassium acetate, potassium formate and potassium propionate, 2,4,6-tris(dimethylaminomethyl)phenol, N,N′,N″-tris(dimethylaminopropyl)hexahydrotriazine and diaza-bis-cycloalkene, and the like, and mixtures thereof.

Silicone copolymer (d) is a linear, branched or comb siloxane copolymers or terpolymers with pendant polyether epoxy (oxyrane) groups that are included in the final composition for use in polyurethane foams as cell regulators or bulk stabilizer. Silicone copolymer (d) acts as a surfactant herein. The length of silicone backbone, specific pendant polyether substituents, average atomic masses of polyether substituents, alkylene oxide residue content of various polyether substituents, can all be altered to provide polyurethane foam with desired properties.

In one embodiment, silicone copolymer (d) can have the generalized average formula:
MD_{xD″}_{y}M*_{z}
wherein
M represents (CH₃)₃ SiO_{1/2};
M* represents R(CH₃)₂ SiO_{1/2};
D represents (CH₃)₂ SiO_{2/2};
D″ represents (CH₃)(R)SiO_{2/2};
x is of from about 0 to about 70;
y is of from about 0 to about 20; and
z is from 0 to 2
in the above formulae for M* and D″,
R is alkyl oxyrane or a substituent derived from CₙH₂ₙ₋₁ started polyether and is selected from the group consisting of:

(i) —CₙH₂ₙO(C₂H₄O)ₐ(C₃H₆O)_{b}R″ having an average atomic mass of from about 50 to about 4000, and wherein

n is of from about 2 to about 18;

a is a number such that ethylene oxide residue constitutes of from about 0 to about 100 weight percent of alkylene oxide residue of polyether (i);

b is a number such that propylene oxide residue constitutes of from about 0 to about 100 weight percent of alkylene oxide residue of polyether (i);

R″ represents H, an alkyl group comprising of from about 1 to about 4 carbon atoms, —C(O)CH₃, or OAc; and

(ii) —Cn′H_{2n′}O(C₂H₄O)_{a′}(C₃H₆O)_{b′} R″ having an average atomic mass of from about 50 to about 4000, and wherein

n′ is of from about 2 to about 18;

a′ is 0 to a number such that ethylene oxide residue constitutes up to about 0 to about 100 weight percent of alkylene oxide residue of polyether (ii); and

b′ is 0 to a number such that propylene oxide residue constitutes up to about 0 to about 100 weight percent of alkylene oxide residue of polyether (ii);

with the proviso that at least one of a′ and b′ must be finite; and

R″ is an oxyrane or epoxy containing end group.

As stated above, length of silicone backbone can be altered to provide polyurethane foam properties. In one specific embodiment, x can be of from about 0 to about 12 and y+z can be of from about 0 to about 4. In another embodiment, x can be of from about 4 to about 8 and y+z can be of from about 0 to about 2. It will be understood by a person skilled in the art that these ranges include all subranges there between.

In another embodiment, polyether-comprising substituent R is derived from allyl-started, acetoxy-capped polyether and is selected from the group consisting of polyether (i) having an average atomic mass of from about 50 to about 4000 wherein a is a number such that ethylene oxide residue constitutes of from about 0 to about 100 weight percent of alkylene oxide residue of polyether (i) and wherein b is a number such that propylene oxide residue constitutes of from about 0 to about 100 weight percent of alkylene oxide residue of polyether (i); polyether (ii) having an average atomic mass of from about 50 to about 4000; wherein a′ is a number such that ethylene oxide residue constitutes either about 100 weight percent or alternatively about 0 weight percent of alkylene oxide residue of polyether (ii) and wherein b′ is a number such that propylene oxide residue constitutes either about 0 weight percent or alternatively about 100 weight percent, respective to a′, of alkylene oxide residue of polyether (ii); and combinations thereof, with the proviso that the overall average atomic mass of polyether-comprising substituent R, which is derived from alcohol started, allyl, methallyl or vinyl-capped polyether is of from about 0 to about 90. It will be understood by a person skilled in the art that these ranges include all subranges there between.

In one embodiment of the invention, the silicone copolymer (d) can be selected from the group consisting of Voranol®, Arcol®, Hyperlite® Stepanol® and combinations thereof.

In a another embodiment of the invention, there is provided a process of preparing polyurethane foam, which comprises the steps of:

(1) preparing at least one mixture of polyurethane foam-forming composition comprising:

(a) polyether, polyester or polymer polyol;

(b) organic diisocyanate or polymeric isocyanate;

(c) catalyst for production of polyurethane foam;

(d) silicone copolymer having an alkyl, aryl, polyether, polyester, pendant groups with at least one oxyrane or epoxy functionality. Wherein the (d) silicone copolymer has the generalized average formula
MDₓD″_{y}M*_{z}
wherein
M represents (CH₃)₃ SiO_{1/2};
M* represents R(CH₃)₂ SiO_{1/2};
D represents (CH₃)₂ SiO_{2/2};
D″ represents (CH₃)(R)SiO_{2/2};
x is of from about 0 to about 70;
y is of from about 0 to about 20; and
z is from 0 to 2
in the above formulae for M* and D″,
R is substituent derived from allyl-started, epoxy-capped polyether and is selected from the group consisting of:
(i) —CₙH₂ₙO(C₂H₄O)ₐ(C₃H₆O)_{b}R″ having an average atomic mass of from about 50 to about 150, and wherein
n is of from about 3 to about 4;
a is a number such that ethylene oxide residue constitutes of from about 0 to about 100 weight percent of alkylene oxide residue of polyether (i);
b is a number such that propylene oxide residue constitutes of from about 0 to about 100 weight percent of alkylene oxide residue of polyether (i);
R″ represents H, an alkyl group comprising of from about 1 to about 4 carbon atoms, or —C(O)CH₃; and
(ii) —C_{n′}H_{2n′}O(C₂H₄O)_{a′}(C₃H₆O)_{b}R″ having an average atomic mass of from about 50 to about 150, and wherein
n′ is of from about 2 to about 4;
a′ is 0 to a number such that ethylene oxide residue constitutes either greater than about 100 weight percent or alternatively of from about 0 to about 100 weight percent of alkylene oxide residue of polyether (ii); and
b′ is 0 to a number such that propylene oxide residue constitutes either less than about 100 weight percent or alternatively of from about 0 to about 100 weight percent, respective to a′, of alkylene oxide residue of polyether (ii); with the proviso that at least one of a′ and b′ must be finite; and
R″ is an oxyrane or epoxy containing end group.
It will be understood by a person skilled in the art that these ranges include all subranges there between.

In one embodiment of the present invention, a blowing agent such as water is employed to generate carbon dioxide in situ. Ancillary blowing agents, which are vaporized by the exotherm of reaction, have been used in the past and may be used herein, but, unless otherwise indicated, no ancillary blowing agents are necessary to utilize surfactants herein. Most of blow in polyurethane foam formed herein specifically will be the result of reaction of added water with isocyanate because ozone depleting or volatile organic compound (VOC) reagents are not required herein.

In one embodiment, other additives may be added to polyurethane foam to impart specific properties to polyurethane foam, including, but not limited to, fire retardant, stabilizer, coloring agent, filler, anti-bacterial agent, cross-linking agent, extender oil, anti-static agent, solvent and combinations thereof.

In another embodiment of the present invention, there is also provided a process of preparing polyurethane foam which comprises the steps of preparing at least one mixture of polyether polyol (a), organic diisocyanate (b), catalyst for production of polyurethane foam (c), and silicone copolymer (d); allowing at least one mixture to foam; and curing foamed mixture. The term “mixture” as used in this embodiment does not require that no chemical reactivity has occurred in mixture, on the contrary, polyol (a), organic diisocyanate or polymeric isocyanate (b), catalyst for production of polyurethane foam (c), and silicone copolymer (d) do chemically react to form polyurethane foam, which can be cured.

Specifically, polyurethane foam herein can be formed in accordance with any processing techniques known to the art, such as, in particular, the “one shot” technique. In accordance with this process, polyurethane foam product is provided by carrying out reaction of polyether polyol (a) and diisocyanate (b) simultaneously with foaming operation. It is sometimes convenient to add silicone copolymer (d) to reaction mixture as premixture with at least one of polyether polyol (a), organic diisocyanate (b), catalyst for production of polyurethane foam (c), blowing agent and any of the other additives.

In one specific embodiment, polyether polyol (a), silicone copolymer (d), catalyst for production of polyurethane foam (c), such as amine catalyst, and blowing agent are mixed together, then stannous octoate as second catalyst for production of polyurethane foam (c) is added with stirring, and finally organic diisocyanate (b) such as, toluene diisocyanate is mixed in and polyurethane foam-forming composition is allowed to foam and polymerize.

Polyurethane foam produced by polyurethane foam-forming composition can have various physical parameters dependant on specific components used. A person skilled in the art can vary specific components based upon desired properties of polyurethane foam and intended use of polyurethane foam.

When polyurethane foam is manufactured, the high density of polyurethane foam limits the height that polyurethane foam buns can be successfully produced. Since polyurethane foam properties are related to density and airflow, if these key characteristics vary too greatly polyurethane foam at the bottom of buns and top of the buns possess different performance. The magnitude of density and airflow gradients can be controlled by performance of silicone copolymer (d) as well as selection of polyether polyol (a), organic diisocyanate (b) and catalyst for production of polyurethane foam (c). In one specific embodiment, polyurethane foam has a density of from about 0.5 to about 100 kgrams per meter³.

In a more specific embodiment, polyurethane foam has a density of from about 20 to about 75 kilograms per meter³.

In a most specific embodiment, polyurethane foam has a density of from about 25 to about 45 kilograms per meter³ It will be understood by a person skilled in the art that these ranges include all subranges there between.

### EXAMPLES

The following Examples demonstrate the positive influence of epoxy containing silicone surfactant on reduction of overall volatile organic compounds (VOC) emissions in finished polyurethane foam products of similar physical properties. The physical properties of the Examples are listed in Table 2 as represented by force to crush (FTC) and indentation load deflection (ILD).

As used in these examples, the following designations, terms, and abbreviations shall have the following meanings:

Arcol Polyol E-848 is a polyether polyol from the Bayer Corporation.

Arcol Polyol E-850 is a polymer polyol from the Bayer Corporation.

DEOA-LF: is diethanolaminefrom is a crosslinker from the Dow Chemical Company.

Niax A-1 (General Electric Company): is a blowing amine catalyst, 70% weight bis(2,2′-dimethylaminoethyl ether) in 30% dipropylene glycol.

Niax A-33 (General Electric Company): is a gelling amine catalyst, 33% weight triethylenediamine in 67% dipropylene glycol

TDI=Toluene diisocyanate (T-80)

Index=“Isocyanate Index” means the actual amount of polyisocyanate used divided by the theoretically required stoichiometric amount of polyisocyanate required to react with all the active hydrogen in the reaction mixture multiplied by one hundred (100).

The silicone copolymer surfactant of Comparative Examples A and B, and Examples 1 and 2 were used in the polyurethane foam formulation listed in Table 1.

TABLE 1
Formulation:

| Material | PPHP |
|---|---|
| Arcol Polyol E-848 | 70 |
| Arcol Polyol E-850 | 30 |
| Water | 4.07 |
| DEOA-LF | 1.41 |
| Niax A-1 | 0.09 |
| Niax A-33 | 0.32 |
| Surfactant | 1 |
| TDI | 48.67 |
| Index | 100 |

TABLE 2

| | | Surfactant | | | VOC wt. | VOC wt. | | |
|---|---|---|---|---|---|---|---|---|
| Surfactant | | Concentration | FTC | ILD | (initially) | (Final) | % Loss | Difference |
| Comparative | M′D4M′ + C6 | 0.6 | 299.7 | 28.94 | 14.9820 | 14.3725 | 4.0682 | |
| Example A | Branched | | | | | | | |
| | Hydrocarbon | | | | | | | |
| Example 1 | M′D4M′ + AGE | 0.6 | 294.9 | 33.4 | 12.0000 | 11.8750 | 1.0417 | −74.40% |
| Comparative | M′D8M′ + C6 | 0.6 | 166.3 | 26.39 | 11.8706 | 11.6966 | 1.4658 | |
| Example B | Branched | | | | | | | |
| | Hydrocarbon | | | | | | | |
| Example 2 | M′D8M′ + AGE | 0.6 | 352.3 | 30.68 | 11.9300 | 11.7668 | 1.3680 | −6.70% |

Results:

Examples 1 and 2 employed silicone copolymer surfactant (M′DO₀₋₈M′) hydrosiliated with allyl glycicidyl ether (AGE), and Comparative Examples 1 and 2 utilized silicone copolymer surfactant (M′D₀₋₈M′) hydrosilated with a branched C₆ hydrocarbon as representative of a non-functionalized, typical, pendant copolymer. The M′D₈M′ siloxane hydrosiliated with AGE showed gross emission reductions of 6.7 percent compared to the M′D₈M′ siloxane hydrosilated with a branched C₆ hydrocarbon. The M′D₄M′ siloxane hydrosiliated with AGE showed gross emission reductions 74.4 percent as compared to the M′D₄M′ siloxane hydrosilated with a branched C₆ hydrocarbon. As such, the inventive process has been proven to reduce overall emissions in finished polyurethane foam products with similar physical properties.

1. A polyurethane foam-forming composition comprising:
(a) polyether, polyester or polymer polyol;
(b) organic diisocyanate or polymeric isocyanate;
(c) catalyst for production of polyurethane foam;
(d) silicone copolymer having an alkyl, aryl, polyether, polyester, pendant groups with at least one oxyrane or epoxy functionality.

2. The polyurethane foam-forming composition of claim 1, wherein the (d) silicone copolymer has the generalized average formula:
MDₓD″_{y}M*_{z}
wherein
M represents (CH₃)₃ SiO_{1/2};
M* represents R(CH₃)₂ SiO_{1/2};
D represents (CH₃)₂ SiO_{2/2};
D″ represents (CH₃)(R)SiO_{2/2};
x is of from about 0 to about 70;
y is of from about 0 to about 20; and
z is from 0 to 2
in the above formulae for M* and D″,
R is alkyl oxirane or a substituent derived from CₙH₂ₙ₋₁ started polyether and is selected from the group consisting of:
(i) —CₙH₂ₙO(C₂H₄O)ₐ(C₃H₆O)_{b}R″ having an average atomic mass of from about 50 to about 4000, and wherein
n is of from about 2 to about 18;
a is a number such that ethylene oxide residue constitutes of from about 0 to about 100 weight percent of alkylene oxide residue of polyether (i);
b is a number such that propylene oxide residue constitutes of from about 0 to about 100 weight percent of alkylene oxide residue of polyether (i);
R″ represents H, an alkyl group comprising of from about Ito about 10 carbon atoms, —C(O)CH₃ or OAc; and
(ii) —C_{n′}H_{2n′}O(C₂H₄O)_{a′}(C₃H₆O)_{b′} R″ having an average atomic mass of from about 50 to about 4000, and wherein
n′ is of from about 2 to about 10;
a′ is 0 to about 100 weight percent of alkylene oxide residue of polyether (ii); and
b′ is 0 to about 100 weight percent of alkylene oxide residue of polyether (ii);
with the proviso that at least one of a′ and b′ must be finite; and
R″ is an oxyrane or epoxy containing end group.

3. The polyurethane foam-forming composition of claim 2 wherein x is of from about 0 to about 70 and y is of from about 0 to about 20 and z is 0 to 2.

4. The polyurethane foam-forming composition of claim 2 wherein polyether-comprising substituent R is derived from epoxy terminated polyether and is selected from the group consisting of polyether (i) having an average atomic mass of from about 50 to about 4000; wherein a is a number such that ethylene oxide residue constitutes of from about 0 to about 100 weight percent of alkylene oxide residue of polyether (i) and wherein b is a number such that propylene oxide residue constitutes of from about 0 to about 100 weight percent of alkylene oxide residue of polyether (i); polyether (ii) having an average atomic mass of from about 50 to about 4000; alternatively of from about 0 to about 100 weight percent of alkylene oxide residue of polyether (ii) and alternatively of from about 0 to about 100 weight percent, respective to a′, of alkylene oxide residue of polyether (ii); and combinations thereof, with the proviso that the overall average atomic mass of polyether-comprising substituent R, which is derived from allyl-started, methoxy or acetoxy-capped polyether is of from about 0 to about 99.

5. The polyurethane foam-forming composition of claim 1, wherein the (d) silicone copolymer has the generalized average formula:
M′D₄M
M′ represents R(CH₃)₂ SiO_{1/2};
D represents (CH₃)₂ SiO_{2/2};
M represents (CH₃)₃ SiO_{1/2};
R is allyl glycidyl ether or 1-Allyloxy-2,3-epoxypropane, Allyl glycidyl ether, (1-Allyloxy-2,3-epoxypropane), Allyl 2,3-epoxypropyl ether for synthesis; AGE, [(2-Propenyloxy)methyl]oxyrane, 1-Allyloxy-2,3-epoxipropane having the formula of C₆H₁₀O₂

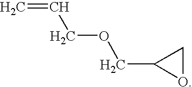

6. The polyurethane foam-forming composition of claim 1, wherein the (d) silicone copolymer has the generalized average formula:
M′D₈M
M′ represents R(CH₃)₂ SiO_{1/2};
D represents (CH₃)₂ SiO_{2/2};
M represents (CH₃)₃ SiO_{1/2};
R is ally glycidyl ether or 1-Allyloxy-2,3-epoxypropane, Allyl glycidyl ether, (1-Allyloxy-2,3-epoxypropane), Allyl 2,3-epoxypropyl ether for synthesis, AGE; [(2-Propenyloxy)methyl]oxyrane, 1-Allyloxy-2,3-epoxipropane having the formula of C₆H₁₀O₂

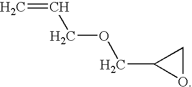

7. The polyurethane foam-forming composition of claim 1 wherein the polyol is selected from the group consisting of aliphatic and aromatic polyester polyols, polyether polyols, polyhydroxy polycarbonates, polyhydroxy polyacetals, polyhydroxy polyacrylates, polyhydroxy polyester amides and polyhydroxy polythioethers, polyolefin polyols, and mixtures thereof.

8. The polyurethane foam-forming composition of claim 1 wherein the polyol has a functionality of at least 2.

9. The polyurethane foam-forming composition of claim 1 wherein the catalyst is trimerization catalyst for the production of polyisocyanurate containing polyurethane foam wherein the polyol has a functionality of at least two

10. The polyurethane foam-forming composition of claim 8 wherein the polyol has a functionality of from about 2 to about 12.

11. The polyurethane foam-forming composition of claim 9 wherein the polyol has a functionality of from about 2 to about 12.

12. The polyurethane foam-forming composition of claim 1 wherein the organic diisocyanate selected from the group consisting of toluene diisocyanate, diphenylmethane isocyanate, methylene diphenyl diisocyanate (MDI), 2,4-toluene diisocyanate (TDI), 2,6-toluene diisocyanate (TDI), including polymeric versions and mixture thereof.

13. The polyurethane foam-forming composition of claim 10 wherein the 2,4-toluene diisocyanate is present in an amount of from about 80 to about 85 weight percent and wherein 2,6-toluene diisocyanate is present in an amount of from about 20 to about 15 weight percent.

14. The polyurethane foam-forming composition of claim 1 wherein the Isocyanate Index is of from about 60 to about 300.

15. The polyurethane foam-forming composition of claim 12 wherein the Isocyanate Index is of from about 70 to about 200.

16. The polyurethane foam-forming composition of claim 13 wherein the Isocyanate Index is of from about 80 to about 120.

17. The polyurethane foam-forming composition of claim 1 wherein the catalyst for production of polyurethane foam (c) is an organoamine, an organotin, di-metallic cyanide, an metal salt, quaternary ammonium salts and mixtures thereof.

18. The polyurethane foam-forming composition of claim 1 wherein the polyurethane foam has a density of from about 5 to about 100 kgrams per meter³.

19. The polyurethane foam-forming composition of claim 18 wherein the polyurethane foam has a density from about 20 to about 75 kilograms per meter³.

20. The polyurethane foam-forming composition of claim 19 wherein the polyurethane foam has a density from about 25 to about 45 kilograms per meter³.

21. A process of preparing polyurethane foam, which comprises the steps of:
(1) preparing at least one mixture of polyurethane foam-forming composition comprising:
(a) polyether, polyester or polymer polyol;
(b) organic diisocyanate or polymeric isocyanate;
(c) catalyst for production of polyurethane foam;
(d) silicone copolymer having an alkyl, aryl, polyether, polyester, pendant groups with at least one oxyrane or epoxy functionality.

22. The process of preparing polyurethane foam of claim 21 wherein mixture of step (i) further comprises co-surfactant, blowing agent, fire retardant, stabilizer, coloring agent, filler, anti-bacterial agent, cross-linking agent, extender oil, anti-static agent, solvent and combinations thereof.

23. A polyurethane foam made by the process of claim 21.
